(19) United States
(12) Patent Application Publication
(10) Pub. No.: US 2009/0201126 A1
(43) Pub. Date: Aug. 13, 2009

(54) Electronic device provided with theft prevention function, and method for preventing theft of electronic devices

(75) Inventor: Yasuyuki Ikeguchi, Itami City (JP)

Correspondence Address: MASUVALLEY & PARTNERS, 8765 AERO DRIVE, SUITE 312, SAN DIEGO, CA, 92123, US

(73) Assignees: Sanyo Electric Co., Ltd., Moriguchi City (JP); Sanyo Visual Technology Inc., Daito City (JP)

(21) Appl. No.: 12/069,707

(22) Filed: Feb. 11, 2008

(51) Int. Cl. G05B 19/04

(52) U.S. Cl. 340/5.2

(57) ABSTRACT

An electronic device includes a first rewritable nonvolatile memory storing a first lock release code, a comparing portion comparing the first lock release code with a second lock release code that is input with an input device, a controlling portion permitting the electronic device to operate normally if the comparing portion finds that the first lock release code matches the second lock release code, and a first error checking portion checking whether or not there is an error in the first lock release code stored in the first rewritable nonvolatile memory. If the first error checking portion finds an error in the first lock release code stored in the first rewritable nonvolatile memory, the controlling portion permits the electronic device to operate normally regardless of a comparison result obtained by the comparing portion.

### BACKGROUND OF THE INVENTION

1. Field of the Invention

The present invention relates to an electronic device provided with theft prevention function, and to a method for preventing theft of electronic devices.

2. Description of Related Art

Conventionally, a typical method for preventing theft of electronic devices is to, for example, embed a sensor called a sensor tag in a piece of merchandise or to attach the sensor tag to a carton case of the merchandise, and install a sensor in the doorway of a store to detect and sound a buzzer when the merchandise is removed from the store without deactivating the function of the sensor at a cash register. However, questions are raised about the effectiveness of this method because the sensor tag loses its effect once it is detached, and the electronic devices are nevertheless stolen even if the buzzer goes off.

And, JP-A-2007-81669 discloses a method for preventing theft of a television receiver. This invention is to directed to a method of storing the contact information of a user in a television receiver, and informing the user of theft via a network if the television receiver is judged to have been stolen.

Also, JP-A-2001-347894 discloses a theft prevention method for use in a motor vehicle. In this invention, in-vehicle electrical components are disabled once a vehicle is put on the alert in case of theft. Thereafter, the in-vehicle electrical components remain disabled unless they are brought out of the disabled state in some way. The method for bringing the in-vehicle electrical components out of the disabled state is to match a unique signal stored in the antitheft device on the vehicle with an unique signal stored in a memory provided separately.

Further, U.S. Pat. No. 4,987,594 discloses an invention which makes a radio receiver or a television receiver unusable by blocking a reception signal or generating a sound if no permission for the use is given, and thereby prevents theft of these receivers.

However, none of these inventions described above is adequate to prevent theft of electronic devices from stores.

It is for this reason that, as an electronic device having a function of preventing theft of electronic devices from stores, an electronic device has been proposed that is permitted to operate normally only when a first lock release code that is previously stored in a memory thereof matches a second lock release code that is input with an input device (U.S. patent application Ser. No. 11/895849). An authorized purchaser can use the electronic device without any problem because they can get a correct second lock release code in the store, for example. By contrast, a person who is not an authorized purchaser cannot operate the electronic device normally because they cannot input a correct second lock release code. In this way, this electronic device produces an effect of preventing theft of electronic devices from stores.

To enhance the effect of preventing theft of electronic devices, it is preferable that different first lock release codes be set one for each of the electronic devices. For this purpose, it is necessary to store the first lock release code in a rewritable nonvolatile memory. However, there is a possibility that the memory contents of the rewritable nonvolatile memory may be corrupted due to some unforeseen events. If the first lock release code stored in the rewritable nonvolatile memory is corrupted, it will never match a second lock release code even if an authorized purchaser inputs a correct second lock release code. As a result, there is a possibility that even an authorized purchaser cannot operate the electronic device normally.

Incidentally, such electronic devices are generally designed as follows. Once a correct second lock release code is input, a flag (hereinafter a “lock release flag”) indicating that the lock has been released is stored in the rewritable nonvolatile memory, and a further input of the second lock release code is not requested. However, there is a possibility that the lock release flag stored in the rewritable nonvolatile memory may be corrupted due to some unforeseen events. If the lock release flag stored in the rewritable nonvolatile memory is corrupted, the user is requested to input the second lock release code again. This will cause a great deal of inconvenience to the user.

### SUMMARY OF THE INVENTION

According to one aspect of the present invention, an electronic device is provided with: a first rewritable nonvolatile memory storing a first lock release code; a comparing portion comparing the first lock release code with a second lock release code that is input with an input device; a controlling portion permitting the electronic device to operate normally if the comparing portion finds that the first lock release code matches the second lock release code; and a first error checking portion checking whether or not there is an error in the first lock release code stored in the first rewritable nonvolatile memory. If the first error checking portion finds an error in the first lock release code stored in the first rewritable nonvolatile memory, the controlling portion permits the electronic device to operate normally regardless of a comparison result obtained by the comparing portion.

Preferably, the electronic device is further provided with: a second rewritable nonvolatile memory storing a lock release flag indicating whether or not a lock has been released; and a second error checking portion checking whether or not there is an error in the lock release flag stored in the second rewritable nonvolatile memory. If the second error checking portion finds an error in the lock release flag stored in the second rewritable nonvolatile memory, the controlling portion permits the electronic device to operate normally regardless of a comparison result obtained by the comparing portion.

Preferably, data used by the first error checking portion when performing an error check is stored in the first rewritable nonvolatile memory, and data used by the second error checking portion when performing an error check is stored in the second rewritable nonvolatile memory.

Preferably, the first rewritable nonvolatile memory and the second rewritable nonvolatile memory form a single memory.

An example of the electronic device is a television receiver.

Preferably, the input device is a remote control transmitter provided separately from the electronic device, and the electronic device includes a receiving portion for receiving a signal transmitted from the remote control transmitter.

According to another aspect of the present invention, a method for preventing theft of an electronic device is provided with the steps of: storing a lock release code in a first rewritable nonvolatile memory of the electronic device; generating information corresponding to the lock release code stored in the first rewritable nonvolatile memory; making the electronic device request an input of the information corresponding to the lock release code; comparing the input information with the lock release code stored in the first rewritable nonvolatile memory; permitting the electronic device to operate normally if the input information is found to match the lock release code in the comparing step; checking whether or not there is an error in the lock release code stored in the first rewritable nonvolatile memory; and permitting the electronic device to operate normally regardless of a comparison result obtained in the comparing step if an error is found in the lock release code stored in the first rewritable nonvolatile memory in the step of checking an error in the lock release code.

Preferably, the method for preventing theft of an electronic device is further provided with the steps of: checking whether or not there is an error in a lock release flag indicating whether or not a lock has been released, the lock release flag being stored in a second rewritable nonvolatile memory of the electronic device; and permitting the electronic device to operate normally regardless of a comparison result obtained in the comparing step if an error is found in the lock release flag stored in the second rewritable nonvolatile memory in the step of checking an error in the lock release flag.

Preferably, data used when the step of checking an error in the lock release code is performed is stored in the first rewritable nonvolatile memory, and data used when the step of checking an error in the lock release flag is performed is stored in the second rewritable nonvolatile memory.

Preferably, the first rewritable nonvolatile memory and the second rewritable nonvolatile memory form a single memory.

An example of the electronic device is a television receiver.

Preferably, an input device for inputting the information corresponding to the lock release code is a remote control transmitter provided separately from the electronic device, and the electronic device includes a receiving portion for receiving a signal transmitted from the remote control transmitter.

### BRIEF DESCRIPTION OF THE DRAWINGS

FIG. 1 is a block diagram of a television receiver according to the present invention.

FIG. 2 shows a portion of a production process of the television receiver shown in FIG. 1.

FIG. 3 shows a procedure for issuing information corresponding to a lock release code.

FIG. 4 shows an example of a flowchart of operation of the television receiver shown in FIG. 1.

FIG. 5 is an example of a screen in which a television receiver requests an input of information corresponding to a lock release code.

FIG. 6 shows an example of a screen when a user inputs information which does not match a lock release code.

### DETAILED DESCRIPTION OF PREFERRED EMBODIMENTS

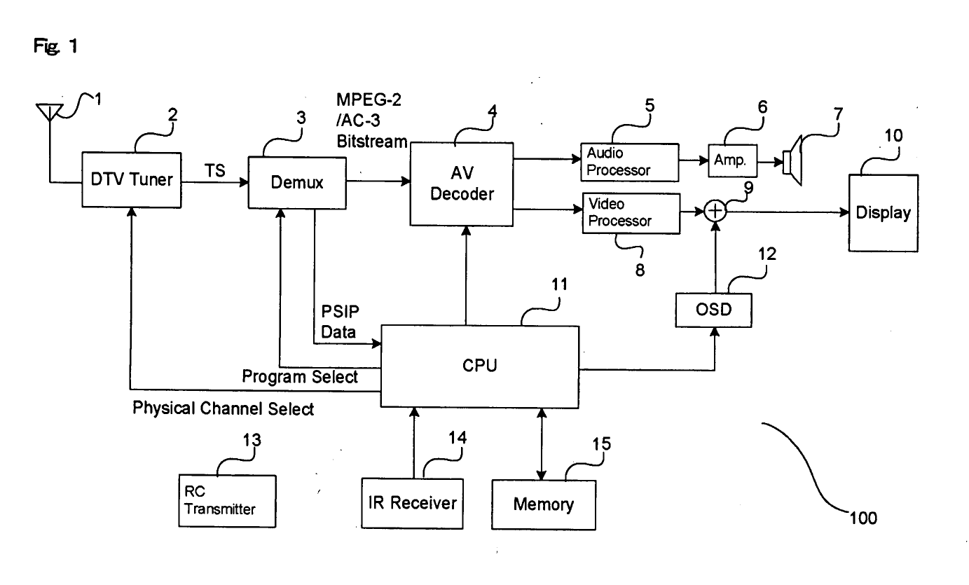

FIG. 1 shows a block diagram of a television receiver 100 according to the present invention. In this embodiment, an U.S. digital television receiver which receives an ATSC (Advanced Television Systems Committee) signal is described as an embodiment.

A terrestrial antenna 1 receives a digital terrestrial broadcasting wave, and supplies a received signal to a digital terrestrial tuner 2. The digital terrestrial tuner 2 selects a physical channel by a channel select signal from a CPU or a microprocessor 11. The digital terrestrial tuner 2 converts a high frequency 8VSB (8-level vestigial sideband) digital modulation signal including video/audio data to a specific frequency signal by this channel select process. Also, the digital terrestrial tuner 2 is provided with an 8VSB demodulation circuit or the like to demodulate the digital modulation signal of selected physical channel, and outputs a transport stream TS.

A demultiplexer (DEMUX) 3 divides the transport stream TS received from the digital terrestrial tuner 2 into a predetermined packet, namely a video stream of MPEG-2, an audio stream of AC-3 (AC-3 is a registered trade mark of Dolby Laboratories Licensing Corporation), and PSIP (Program and System Information Protocol) data, and receives a program select signal from the CPU 1. The demultiplexer 3 supplies the video stream and the audio stream to an AV decoder 4, and PSIP data, which includes program information, is supplied to the CPU 11.

The CPU 11 performs various controls of the television receiver 100, as well as processing of the PSIP data, and processing of remote control signals described later. A memory 15 is connected to the CPU 11, and the memory 15 stores various data including the program information and a lock release code described later.

A plurality of virtual channels are multiplexed into the transport stream TS, and selection of any one of the plurality of virtual channels is made possible by collecting the VCT (virtual channel table) from the transport stream TS and identifying a given packet ID by referring to the VCT thus collected.

An AV decoder 4 is provided with an MPEG video decoder (not shown) for decoding the MPEG-2 bit stream, and an AC-3 decoder (not shown) for decoding the audio stream (AC-3 bit stream). The video data generated by the decoder of AV decoder 4 is output to a video processor 8, and the audio data is output to an audio processor 5.

The video processor 8 receives the video data from the AV decoder 4 and generates a video signal by performing D/A conversion. The audio processor 5 receives the audio data output from the AV decoder 4 and generates an analog audio signal by performing D/A conversion.

An OSD (On Screen Display ) circuit 12 outputs a video signal to an adder 9 based on the character information instructed to output from the CPU 11. The adder 9 adds the video signal based on the bitmap data and the reception video signal, and supplies the resultant video signal to a display 10, such as an LCD.

The display 10 displays images according to the video signal supplied from the video processor 8. Also, the analog audio signal from the audio process circuit 5 is output from a speaker 7 after being amplified with an amplifier 6.

A remote control transmitter 13 is a transmitter to transmit various instructions to the television receiver 100. When a key (not shown) provided on this remote control transmitter 13 is operated, an IR (Infrared) signal (remote control signal), which is an instruction corresponding to the key, is transmitted from a light emitting portion (not shown). An IR receiver 14 receives the signal light, converts it into an electrical signal, and supplies it to the CPU 11.

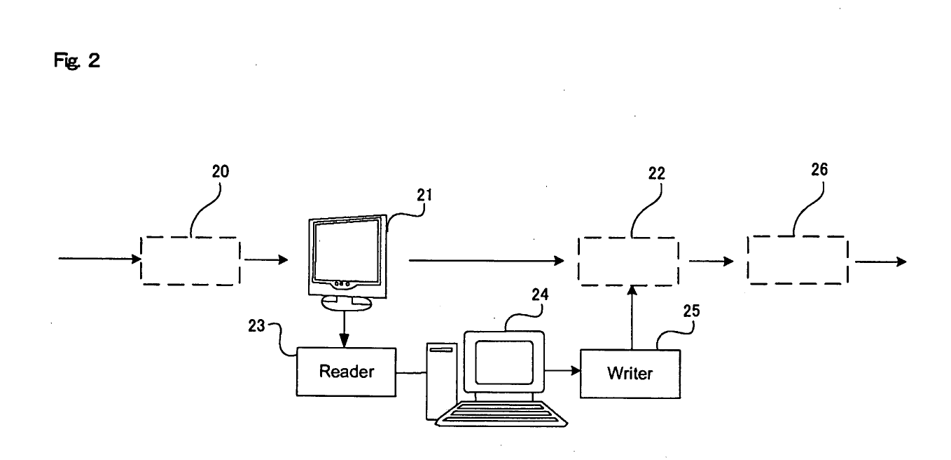

FIG. 2 shows a portion of a production process of the television receiver shown in FIG. 1. Each television receiver manufactured in a factory may be provided with a serial number. The serial number may be provided by attaching a barcode indicating the serial number onto the main body of the television receiver. The code other than a barcode, such as a two-dimensional code, may be used instead.

As shown in FIG. 2, the television receiver which was subjected to a predetermined process in a manufacturing process 20 is transferred to the next manufacturing process 21. In the manufacturing process 21, the barcode indicating the serial number provided to the television receiver is read by a barcode reader 23. And the serial number is input to a PC (personal computer) 24. The PC 24 has software which is capable of generating different lock release codes, one for each of the serial numbers. The PC 24 creates the lock release code with the software. The created lock release code is transferred to a writer 25.

In a manufacturing process 22, the lock release code is written in the memory 15 of the television receiver by the writer 25. This writer 25 may be a remote controller transmitting portion to transmit the signal of the lock release code received from the PC 24 as an infrared remote control signal. The lock release code transmitted from the writer 25 is received by the IR receiver 14 of the television receiver and stored in the memory 15 through the CPU 11 (shown in FIG. 1). The television receiver storing the lock release code is delivered as goods (process 26).

In this way, one lock release code corresponds to one serial number and is stored in the television receiver. In addition, the information corresponding to the lock release code is generated. The serial number, the information corresponding to the lock release code, and the lock release code correspond to one another. Also, the information corresponding to the lock release code and the lock release code are generated to match.

Reading of the serial number may be in any form. For example, an IIC bus may be used. That is, the serial number is written in the memory 15 of the television receiver in the manufacturing process 20, and the serial number is read into the PC 24 through the IIC bus in the manufacturing process 21.

A lock release code corresponding to the serial number is generated in the PC 24, and the lock release code thus generated may be written on the memory 15 of the television receiver by the IIC bus. Also, the information to create the lock release code is not limited to the serial number, it may be anything. It may be the date of manufacture of the television receiver. The method for generating the lock release code is not limited to that of FIG. 2, it may be any method.

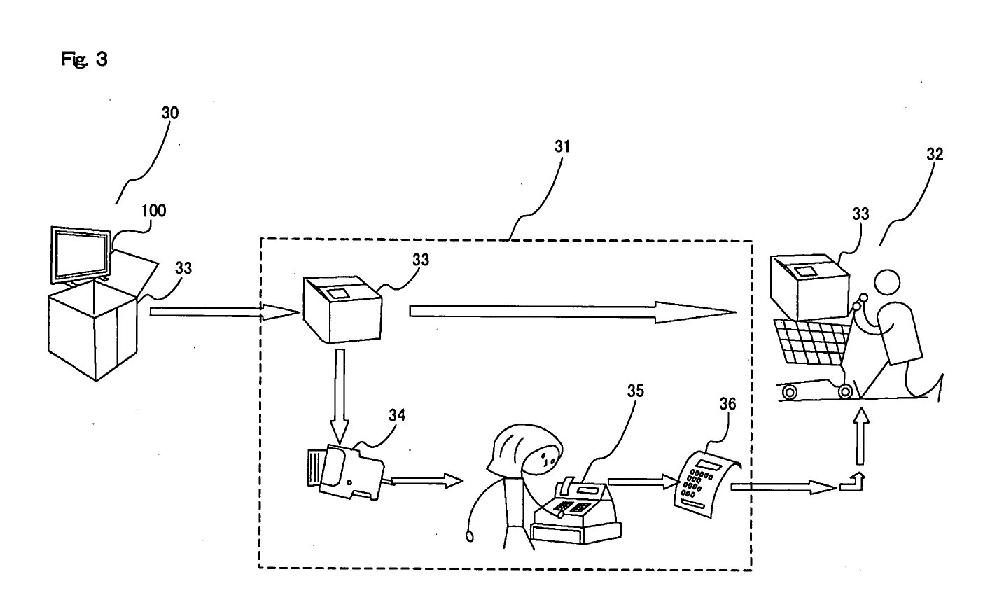

FIG. 3 shows a procedure for issuing the information corresponding to the lock release code. In a manufacturing process 30, the television receiver 100 is packaged. In a sales process 31, the barcode indicating the serial number attached to the packaged television receiver 33 is read by a barcode reader 34. The read serial number is imported to a register device 35. The register device 35 is capable of obtaining the information corresponding to the lock release code from an individual serial number. The obtained information corresponding to the lock release code is printed on a receipt 36 which indicates a record of purchase, and handed to a purchaser (process 32).

The information corresponding to the lock release code is not necessarily printed on a receipt, and it may be given to a purchaser in any form. For example, it may be printed on a separate form from the receipt. Also, reading the serial number is not limited to the barcode reader, it may be transmitted to a register in any form. For example, the serial number may be input to a register directly by a store clerk. Also, instead of transmitting the serial number to the register, the information corresponding to the lock release code may be obtained by transmitting the serial number to another device. Also, the number other than the serial number may be used and it may be in any form, or a time to obtain the information corresponding to the lock release code may be in any form.

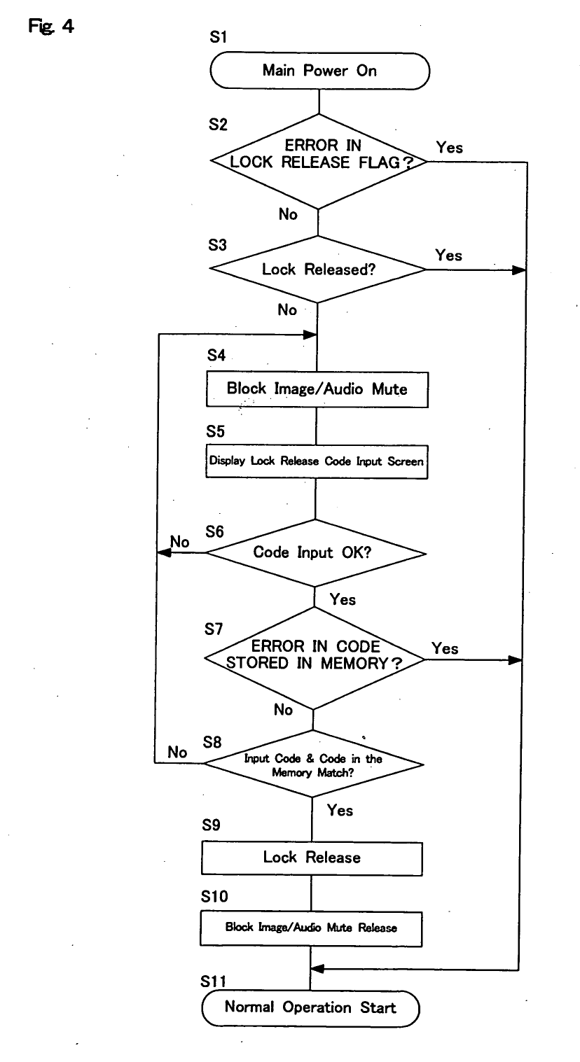

FIG. 4 shows an example of a flowchart of the operation of the television receiver shown in FIG. 1. First, when the power of the television receiver is turned on (step S1), the CPU 11 of the television receiver checks whether or not there is an error in the lock release flag stored in the memory 15 (step S2). If an error is found in the lock release flag, the value indicated by this lock release flag is judged to be unreliable. In this case, the procedure proceeds to step S11, and the television receiver starts normal operation so that the user of the television receiver does not suffer any disadvantage. On the other hand, if no error is found in the lock release flag, the CPU 11 of the television receiver checks if the lock for images and so on has been released or not (step S3). If the lock is found to have been released, the television receiver starts channel select preset operation, image display, and audio output (step S11). If the CPU 11 of the television receiver finds that the lock for the image display and so on has not been released, the image is blocked and the sound is muted (step S4).

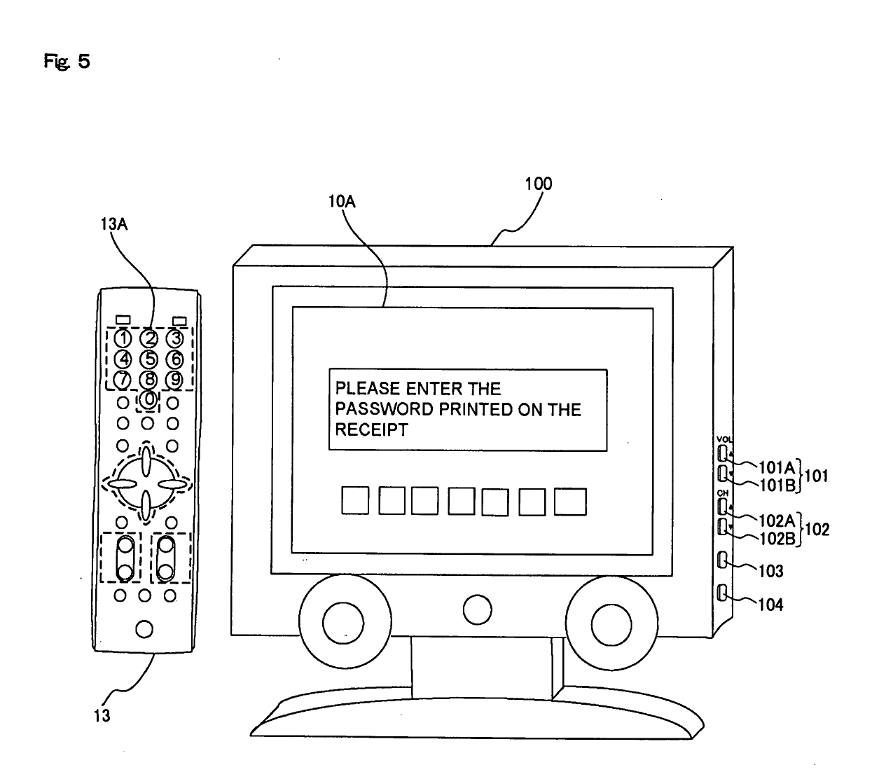

Thereafter, for example, a display requesting an input of the information corresponding to the lock release code is displayed on the screen of the television receiver as explained in FIG. 5 (step S5). The user inputs the information corresponding to the lock release code by using a remote controller or the like according to this instruction. Then, the television receiver determines whether there is an input from the user or not (step S6). When there is no input, the image and the audio are blocked (step S4).

When there is an input, the CPU 11 of the television receiver checks whether or not there is an error in the lock release code stored in the memory 15 (step S7). If an error is found in the lock release code, the value indicated by this lock release code is judged to be unreliable. In this case, the procedure proceeds to step S11, and the television receiver starts normal operation so that the user of the television receiver does not suffer any disadvantage. On the other hand, if no error is found in the lock release code, a determination is made at the comparing portion of the television receiver as to whether the information matches the lock release code or not (step S8). Incidentally, in this embodiment, the CPU 11 of the television receiver functions as the comparing portion of the television receiver. When it is determined that the information does not match the lock release code, images and audio are blocked (step S4). When it is determined that the information matches the lock release code, the lock for the image and the audio is released (step S9). When the lock is released, the image block and the audio mute are released (step S10), the television receiver starts a channel select preset operation, image display, and audio output (step S11).

Incidentally, in this embodiment, at least part of the memory 15 is built with a rewritable nonvolatile memory (such as a flash memory and an EEPROM (electrically erasable and programmable read only memory)), and the lock release flag and the lock release code are stored in the rewritable nonvolatile memory. In this embodiment, after the information corresponding to the lock release code is input by the user operation, the lock release code stored in the memory 15 is checked for an error (see steps S6 and S7). As a result, even if there is an error in the lock release code, since an input of the information corresponding to the lock release code by the user operation is accepted, the user does not feel a sense of discomfort.

Next, error detection performed in step S7 for the lock release code stored in the memory 15 will be described. The description here deals with a case in which a five-digit number, for example, is used as the lock release code. Let the five-digit code be “57485”. If this five-digit code is stored in the memory in ASCII code that is commonly used in the personal computer, 5-byte data “0x35, 0x37, 0x34, 0x38, 0x35” (hexadecimal notation) is stored.

A description will be given below of a case in which, among various error detection schemes, a checksum is employed for performing error detection for the lock release code stored in the memory 15. A checksum is an error detection scheme in which the value of the checksum code is set in such a way that the result obtained by adding the value of the checksum code to the sum of target data values becomes zero. In the example of the lock release code described above, the sum of the target data values is 0x10d, which is given by formula (1) below.

0x35+0x37+0x34+0x38+0x35=0x10d (1)

Adding f3 to 0x10d gives 0x200, as shown in formula (2) below. Since the last 1 byte of 0x200 is 0x00, 0xf3 is set as the value of the checksum code.

0x10d+f3=0x200 (2)

That is, 6-byte data “0x35, 0x37, 0x34, 0x38, 0x35, 0xf3” is stored in the rewritable nonvolatile memory, and, when reading out it, the values of the 6-byte data are added up. If the results show the last 1 byte is 0x00, it can be judged that the correct value is stored in the rewritable nonvolatile memory. On the other hand, if the results show the last 1 byte is other than 0x00, it can be judged that any of these values is corrupted.

In place of a 1-byte checksum, a two or more byte checksum may be used. By using a two or more byte checksum, it is possible to increase the precision of error detection. If a 2-byte checksum is performed for the lock release code described above, the value of the checksum code is 0xfef3.

Needless to say, the error detection scheme for the lock release code is not limited to the checksum described above; it is possible to employ any other error detection scheme.

Next, an error detection scheme for the lock release flag will be described. A description will be given below of error detection performed in step S2 for the lock release flag stored in the memory 15.

The lock release flag makes the television receiver operate in such a way that, once it is judged that the television receiver has received the correct lock release code and is used by the authorized purchaser, the television receiver does not request a further input of the lock release code. Thus, the lock release flag simply has to be data indicating two different states: “Lock” and “Not Lock”, and 1-bit value will suffice.

However, in the example discussed below, as the error detection scheme for the lock release flag, a scheme using multiple bits, such as 8 bits (1 byte), instead of 1 bit will be described. For example, codes are assigned to the above two states as follows.

Lock: 0xaa (=binary code 10101010)

Not Lock: a code other than 0xaa

As described above, a code other than 0xaa is assigned to “Not Lock”. However, this does not mean that any code may be assigned to “Not Lock”. In actual setting, a specific code is assigned. The specific code is, for example, 0x5c (=binary code 01011100). In 0x5c, 6 bits out of 8 bits of 0xaa are inverted; 1 becomes 0, and 0 becomes 1.

Even if some error occurs in the rewritable nonvolatile memory in which the 1-byte lock release flag described above is written, the probability is low that 0x5c changes to 0xaa; practically, there is little or no probability that “Not Lock” changes to “Lock”. On the other hand, if 0xaa changes to other value, it can be judged that some error has occurred in the rewritable nonvolatile memory in which the 1-byte lock release flag is written. Therefore, to avoid creating disadvantage for the user, any value other than 0xaa is judged to indicate “Not Lock”.

Needless to say, the error detection scheme for the lock release flag is not limited to the above-described scheme; it is possible to employ any other error detection scheme.

FIG. 5 shows an example of a screen in which the television receiver is requesting an input of the information corresponding to a lock release code. FIG. 5 shows a television receiver 100 and a remote control transmitter 13, which is an example of the remote controller. The remote control transmitter 13 has a plurality of inputs 13A. The television receiver 100 has a display screen 10A. The display screen 10A is displaying “Please enter the password printed on the receipt”.

A user inputs the information corresponding to the lock release code using the remote control transmitter 13 according to the instruction of the display screen 10A. When the input information matches the lock release code stored in the memory of the television receiver 100, an image is displayed on the display screen 10A. When the input information does not match the lock release code, there is no image display or audio output. The plurality of inputs 13A include an input to correct the input, an input to reset the television receiver 100 to an initial state, and a confirmation key to confirm a predetermined item.

The means for inputting the information is not limited to the example specifically described above, it may be in any form. For example, instead of using the remote controller, the input keys provided on the television receiver may be used. In this case, input of the lock release code may be possible only with input keys 101, 102, and 103 provided on the side of the television receiver as shown in FIG. 5. That is, when the lock release code input screen appears, the volume increase/decrease keys 101 can be used to specify an input position of the lock release code, in such a way that the volume increase key 101A is used to shift the input position of the lock release code rightward with a cursor, and the volume decrease key 101B is used to shift the input position of the lock release code leftward with a cursor. After the input position of the lock release code is specified with the volume increase/decrease keys 101, a number to be input thereto is selected from among 0 to 9 by using the channel up/down keys 102. That is, the channel up key 102A is depressed to increment the number from 0 to 9, and the channel down key 102B is depressed to decrement the number from 9 to 0. Then, after all the numbers of the lock release code are input to their respective input positions, the confirmation key 103 is depressed to confirm the input of the lock release code. Incidentally, reference numeral 104 represents an on/off switch of the television receiver. As described above, by making it possible to input the lock release code only with the input keys provided on the television receiver, only a human being is permitted to perform input operation. This helps prevent automatic input with an intelligent remote controller or the like. Also, the display screen to request a user to input the information may be in any form. For example, in a case where there are a plurality of numbers to be input, the display screen shows a few numbers (for example three numbers) for each of the plurality of numbers to be input, and then shows an input screen for the next numbers. Also, numbers may be displayed on the display screen, and a user may select appropriate numbers by touching the screen where the numbers exist. Also, a column to draw a symbol or simple picture may be displayed on the display screen, and the user may draw the information in the column.

The television receiver may request to enter the information at any time. For example, it may be when the power of the television receiver is turned on, or a few seconds after the power is turned on. Also, the input may be confirmed by using a confirmation key after inputting a plurality of numbers as the information. In such case, if the confirmation key is pressed before inputting all the numbers to be input, the display screen does not change and it may display a screen prompting to continue the input.

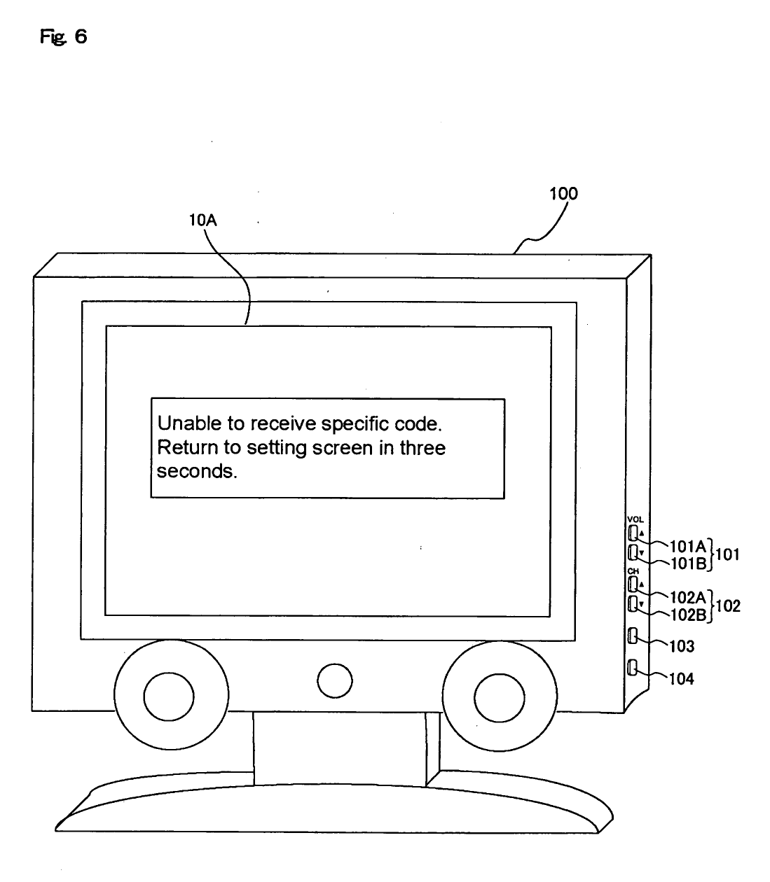

Between step S8 and step S4, a step for displaying a screen shown in FIG. 6, for example, may be provided. In the example shown in FIG. 6, the display screen 10A of the television receiver 100 displays a message “Unable to receive specific code. Return to setting screen in three seconds”, indicating that, since the user inputs the information which does not match the lock release code, an image is not displayed. The display in which the image display is blocked is not limited to that of FIG. 6, and it may be in any form. For example, an X mark may be displayed on the display screen. Also, for example, when the number of incorrect inputs of the information corresponding to the lock release code reaches a predetermined number (which is smaller than the number limit in step S11), contact information on a third party may be displayed. By contacting the third party and providing it with the information such as serial number, the user can obtain the information corresponding to the lock release code from the third party.

The present invention is not limited to the embodiment above. For example, only a television receiver is explained in FIGS. 1 to 6; however, the explanations in FIGS. 1 to 6 may be applied to all the electronic devices, such as VCRs, DVD players, camcorders, vacuum cleaners, electric heaters, air conditioners, rice cookers, digital cameras, land-line phones, cellular phones, personal computers, and electric fans. Also, the electronic devices may be provided with a solar cell.

What is claimed is:

1. An electronic device, comprising:
a first rewritable nonvolatile memory storing a first lock release code;
a comparing portion comparing the first lock release code with a second lock release code that is input with an input device;
a controlling portion permitting the electronic device to operate normally if the comparing portion finds that the first lock release code matches the second lock release code; and
a first error checking portion checking whether or not there is an error in the first lock release code stored in the first rewritable nonvolatile memory,
wherein, if the first error checking portion finds an error in the first lock release code stored in the first rewritable nonvolatile memory, the controlling portion permits the electronic device to operate normally regardless of a comparison result obtained by the comparing portion.

2. The electronic device of claim 1, further comprising:
a second rewritable nonvolatile memory storing a lock release flag indicating whether or not a lock has been released; and
a second error checking portion checking whether or not there is an error in the lock release flag stored in the second rewritable nonvolatile memory,
wherein, if the second error checking portion finds an error in the lock release flag stored in the second rewritable nonvolatile memory, the controlling portion permits the electronic device to operate normally regardless of a comparison result obtained by the comparing portion.

3. The electronic device of claim 2,
wherein data used by the first error checking portion when performing an error check is stored in the first rewritable nonvolatile memory,
wherein data used by the second error checking portion when performing an error check is stored in the second rewritable nonvolatile memory.

4. The electronic device of claim 2, wherein
the first rewritable nonvolatile memory and the second rewritable nonvolatile memory comprise a single memory.

5. The electronic device of claim 1, wherein
the electronic device is a television receiver.

6. The electronic device of claim 1,
wherein the input device is a remote control transmitter provided separately from the electronic device,
wherein the electronic device comprises a receiving portion for receiving a signal transmitted from the remote control transmitter.

7. A method for preventing theft of an electronic device, comprising the steps of:
storing a lock release code in a first rewritable nonvolatile memory of the electronic device;
generating information corresponding to the lock release code stored in the first rewritable nonvolatile memory;
making the electronic device request an input of the information corresponding to the lock release code;
comparing the input information with the lock release code stored in the first rewritable nonvolatile memory;
permitting the electronic device to operate normally if the input information is found to match the lock release code in the comparing step;
checking whether or not there is an error in the lock release code stored in the first rewritable nonvolatile memory; and
permitting the electronic device to operate normally regardless of a comparison result obtained in the comparing step if an error is found in the lock release code stored in the first rewritable nonvolatile memory in the step of checking an error in the lock release code.

8. The method for preventing theft of an electronic device as claimed in claim 7, further comprising the steps of:
checking whether or not there is an error in a lock release flag indicating whether or not a lock has been released, the lock release flag being stored in a second rewritable nonvolatile memory of the electronic device; and
permitting the electronic device to operate normally regardless of a comparison result obtained in the comparing step if an error is found in the lock release flag stored in the second rewritable nonvolatile memory in the step of checking an error in the lock release flag.

9. The method for preventing theft of an electronic device as claimed in claim 8,
wherein data used when the step of checking an error in the lock release code is performed is stored in the first rewritable nonvolatile memory,
wherein data used when the step of checking an error in the lock release flag is performed is stored in the second rewritable nonvolatile memory.

10. The method for preventing theft of an electronic device as claimed in claim 8, wherein
the first rewritable nonvolatile memory and the second rewritable nonvolatile memory comprise a single memory.

11. The method for preventing theft of an electronic device as claimed in claim 7, wherein
the electronic device is a television receiver.

12. The method for preventing theft of an electronic device as claimed in claim 7,
wherein an input device for inputting the information corresponding to the lock release code is a remote control transmitter provided separately from the electronic device,
wherein the electronic device comprises a receiving portion for receiving a signal transmitted from the remote control transmitter.
